(19) United States
(12) Patent Application Publication
(10) Pub. No.: US 2022/0327391 A1
(43) Pub. Date: Oct. 13, 2022

(54) GLOBAL POOLING METHOD FOR NEURAL NETWORK, AND MANY-CORE SYSTEM

(71) Applicant: LYNXI TECHNOLOGIES CO., LTD., Beijing (CN)

(72) Inventors: Haitao QI, Beijing (CN); Han LI, Beijing (CN); Yaolong ZHU, Beijing (CN)

(21) Appl. No.: 17/634,608

(22) PCT Filed: Jul. 30, 2020
(86) PCT No.: PCT/CN2020/105709

§ 371 Date: Feb. 11, 2022

(30) Foreign Application Priority Data
Aug. 27, 2019 (CN) 201910796532.3

(51) Int. Cl. G06N 3/10

(52) U.S. Cl. CPC G06N 3/10

(57) ABSTRACT

Disclosed are a global pooling method for a neural network and a many-core system. The global pooling method for a neural network includes: receiving point data of to-be-processed data sequentially input by a previous network layer; and performing a preset pooling operation on the received point data after each piece of point data is received until the pooling operations of all the point data of the to-be-processed data are completed.

### CROSS-REFERENCE TO RELATED APPLICATION

The present disclosure claims the priority to the Chinese Patent Application No. 201910796532.3 filed with the Chinese Patent Office on Aug. 27, 2019, the entire contents of which are incorporated herein by reference.

### TECHNICAL FIELD

The present disclosure relates to the field of neural network technology, for example, relates to a global pooling method for a neural network, and a many-core system.

### BACKGROUND

With the continuous development of artificial intelligence technology, deep learning has been applied more and more widely. A Convolutional Neural Network (CNN) is a kind of Feedforward Neural Network that involves convolution calculations and has a deep structure, and is one of the representative algorithms of deep learning. The last layer of a conventional CNN is a fully connected layer, in which the number of parameters is very large and overfitting (e.g., Alexnet) can be easily caused. In a CNN model, most parameters are occupied by the fully connected layer, which affects a processing speed and increases processing time. Therefore, a solution of replacing the fully connected layer with global average pooling (GAP) is proposed. However, global pooling leads to a relatively long calculation delay in the related art.

### SUMMARY

The present disclosure provides a global pooling method for a neural network, and a many-core system.

A global pooling method for a neural network is provided to be applied to a many-core system, and includes: receiving point data of to-be-processed data sequentially input by a previous network layer; and performing a preset pooling operation on the received point data after each piece of point data is received until the pooling operations of all the point data of the to-be-processed data are completed.

A many-core system is provided and includes a plurality of processing cores, at least one of the plurality of processing cores performs the following operations: receiving point data of to-be-processed data sequentially input by a previous network layer; and performing a preset pooling operation on the received point data after each piece of point data is received until the pooling operations of all the point data of the to-be-processed data are completed.

A computer-readable storage medium is further provided and has a computer program stored therein. The computer program is executed by a processor to implement the global pooling method for a neural network according to the present disclosure.

A computer program product is further provided. When the computer program product is run on a computer, the computer performs the global pooling method for a neural network according to the present disclosure.

### BRIEF DESCRIPTION OF DRAWINGS

FIG. 1 is a schematic diagram of an ordinary pooling process of a CNN;

FIG. 2 is a schematic diagram of a GAP process;

FIG. 3 is a schematic diagram illustrating row pipeline operation in a many-core system;

FIG. 4 is a flowchart illustrating a global pooling method for a neural network according to the present disclosure;

FIG. 5 is a schematic diagram illustrating a pooling operation performed on a first piece of point data according to the present disclosure;

FIG. 6 is a schematic diagram illustrating a pooling operation performed on a second piece of point data according to the present disclosure;

FIG. 7 is a schematic diagram illustrating a pooling operation performed on an intermediate piece of point data according to the present disclosure;

FIG. 8 is a schematic diagram illustrating a pooling operation performed on a last piece of point data according to the present disclosure;

FIG. 9 is a schematic diagram of data processing time taken by a conventional solution;

FIG. 10 is a schematic diagram of data processing time according to the present disclosure; and

FIG. 11 is a schematic structural diagram of a many-core system according to the present disclosure.

### DETAILED DESCRIPTION OF EMBODIMENTS

The exemplary embodiments of the present disclosure will be described below with reference to the drawings. Despite the exemplary embodiments of the present disclosure illustrated by the drawings, the present disclosure can be implemented in various forms and should not be limited to the embodiments described herein.

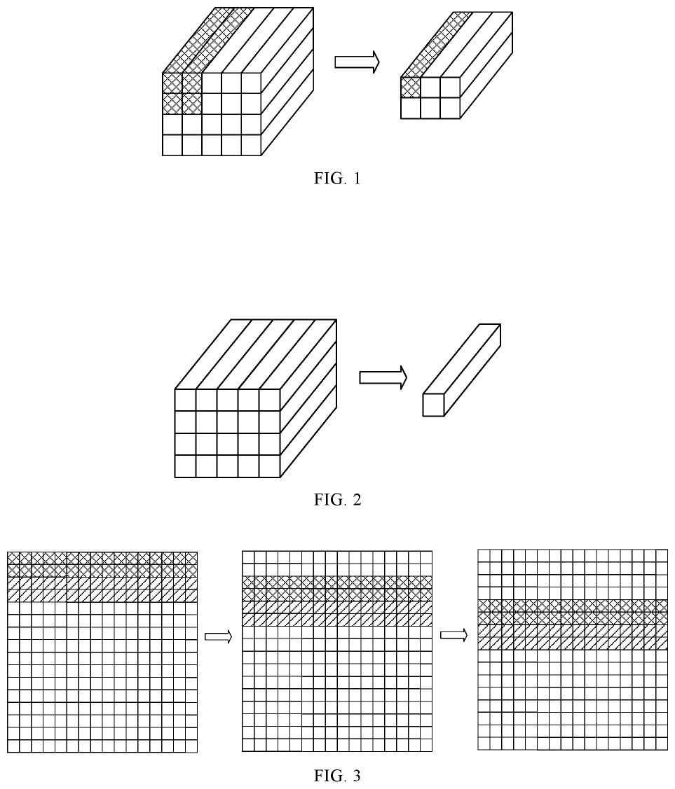

FIG. 1 is a schematic diagram of an ordinary pooling process of a CNN. As can be seen from FIG. 1, in a conventional pooling process, sliding is carried out in a feature map in a form of window (similar to window sliding of convolution), and an operation is performed to take an average value or a maximum value in the window as a result. After such operation, the feature map is down-sampled, and the overfitting is reduced.

On the other hand, the solution of replacing the last layer of the CNN, that is, the fully connected layer, with the GAP is further proposed. Unlike the conventional fully connected layer, according to the solution of the GAP, each feature map (a whole image) is average pooled globally, so that each feature map may produce one output. In this way, compared with the fully connected layer, the GAP can greatly reduce network parameters and avoid the overfitting. Furthermore, each feature map is equivalent to one output feature that represents a feature of an output class.

FIG. 2 is a schematic diagram of a GAP process. As can be seen from FIG. 2, instead of taking an average in the window, the GAP performs averaging by taking a feature map as a unit, that is, one value is output for one feature map.

The network architecture of Network In Network (NIN) replaces the conventional fully connected layer in the CNN with the GAP. In a recognition task using a convolutional layer, the GAP can generate one feature map for each specific class (the number of the features maps generated is the same as that of the classes). The GAP has the advantages that connection between the multiple classes and the feature maps is more apparent (compared with a black box of the fully connected layer), and the feature maps can be converted into classification probability more easily; the problem of overfitting is avoided because no parameters need to be adjusted in the GAP; and the GAP gathers spatial information and thus is more suitable for spatial conversion of inputs.

However, when a whole image is subjected to a GAP operation, the whole image is calculated at one time, and the calculations are performed at one moment. Assuming that storage time of the whole image is t1 and calculation time of the whole image is t2, the time taken for calculating the whole image by adopting the conventional solution is t1+t2. Thus, the conventional solution may easily cause a relatively long calculation delay and great waste of storage capacity.

A many-core system is a multi-core processor including a plurality of processing cores, and is mainly used for floating-point calculations and intensive calculations. Generally, row pipeline operation may be performed in the many-core system, that is, pipeline operation is performed in units of rows. As shown in FIG. 3, assuming that an image has a filter of 3*3 and a stride of 2, an operation of window sliding may be performed when 3 rows of data are stored in a storage space, so that calculation and data reception may be performed in parallel as long as a minimum of 4 rows of data are stored in the storage space, which reduces storage size and improves overall computing power of a chip.

When the row pipeline operation of the many-core system is adopted to perform global pooling, the storage space cannot be saved because a size of a filter for the global pooling is the same as that of the whole image. Thus, an effect of saving the storage space cannot be realized, which is against an original design intention of the many-core system.

The present disclosure provides a global pooling method for a neural network, which is applied to a many-core system. As shown in FIG. 4, the global pooling method for a neural network provided by the present disclosure may include the following operations S401 to S402.

At the operation S401, point data of to-be-processed data sequentially input by a previous network layer is received.

At the operation S402, a preset pooling operation is performed based on currently received point data after each piece of point data is received until the pooling operations of all the point data of the to-be-processed data are completed.

The to-be-processed data may be image data or video data. The neural network may include a plurality of network layers, such as a convolutional layer, a pooling layer, etc. The previous network layer may be any network layer in the neural network that inputs the to-be-processed data to the pooling layer. The network structure and form of the neural network are not limited by the present disclosure.

According to the method provided by the present disclosure, point operation may be used to replace image operation in the row pipeline operation of the many-core system, that is, each piece of point data is processed for one time to obtain an intermediate pooling result after the piece of point data is received until a final pooling result of the to-be-processed data is finally obtained. In this way, there is no need to perform centralized pooling operation after all the point data are received, which effectively reduces the calculation delay.

At the operation S402, when each piece of point data is received, the piece of point data is subjected to the preset pooling operation.

In an optional implementation, the operation S402 may include: receiving a first piece of point data input by the previous network layer, performing the preset pooling operation on the first piece of point data to obtain a first pooling result, and storing the first pooling result; and receiving the other pieces of point data of the to-be-processed data, and performing the preset pooling operation after each of the other pieces of point data is received until the pooling operations of all the point data of the to-be-processed data are completed to obtain a final pooling result.

Assuming that the number of pieces of point data of the to-be-processed data for the whole image is N, for an n^{th} piece of point data, the method may include: receiving the n^{th} piece of point data of the to-be-processed data, and performing the preset pooling operation on the n^{th} piece of point data based on a pooling result of an (n−1)^{th} piece of point data to obtain an n^{th} pooling result, with 1<n<N.

For an N^{th} piece of point data, the method may include: receiving the N^{th} piece of point data of the to-be-processed data and storing in a first storage space, and performing the preset pooling operation on the N^{th} piece of point data based on a pooling result of an (N−1)^{th} piece of point data to obtain an N^{th} pooling result which is the final pooling result of the to-be-processed data. In the present disclosure, the point data may be received in sequence, and each piece of point data received may be subjected to the preset pooling operation and then stored, so as to allow for quickly performing the preset pooling operation on the subsequently received point data.

In the present disclosure, a storage space of the many-core system may be divided in advance, and a first storage space and a second storage space may be selected, so that the point data may be received in sequence, each piece of point data received may be subjected to the preset pooling operation to obtain a pooling result, and the pooling result may be then stored, thereby improving data processing efficiency. The many-core system may include a plurality of processing cores, the storage space of the many-core system may be a storage space of at least one of the plurality of processing cores, but the form of the storage space of the many-core system is not limited by the present disclosure.

In the present disclosure, the pooling operation may be continuously performed on the received point data to obtain the final pooling result of the to-be-processed data. Optionally, the preset pooling operation may include: an average pooling operation or a maximum pooling operation, but the type of the preset pooling operation is not limited by the present disclosure. In an optional embodiment of the present disclosure, since the row pipeline operation of the many-core system may achieve receiving only one piece of point data from the previous network layer at one time, calculation may be performed when the one piece of point data is received. Thus, there is no need to wait until all the point data are received for performing the pooling operation, which may effectively reduce the calculation delay and improve the data processing efficiency.

The average pooling operation and the maximum pooling operation will be separately described below. Data in the first storage space is denoted by A and data in the second storage space is denoted by B.

In a case where the preset pooling operation is the average pooling operation, a process of acquiring the final pooling result of the to-be-processed data may include the following operations S1-1 to S1-3.

At the operation S1-1, a first piece of point data is received and stored in the first storage space as data A₁; and data B in the second storage space is initialized to be 0, and data B₁=A₁*(1/N) is stored in the second storage space. As shown in FIG. 5, the solid pixel block represents the first piece of point data, and the pooling layer of the neural network stores the first piece of point data in the first storage space after receiving the first piece of point data.

At the operation S1-2, an n^{th} piece of point data is received and stored in the first storage space as data Aₙ; and Aₙ is output to the second storage space through a multiplier accumulator to obtain Bₙ=Bₙ₋₁+Aₙ*(1/N).

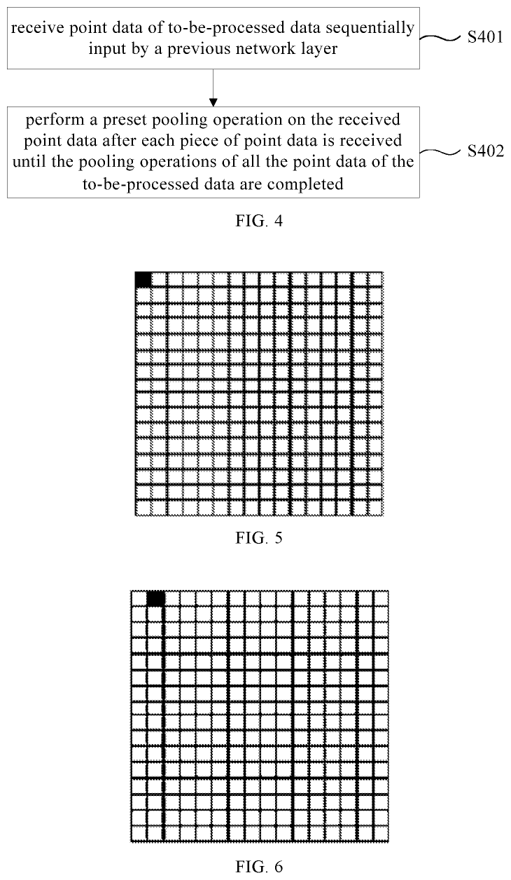

As shown in FIG. 6, when a second piece of point data (the solid pixel block in FIG. 6) is received, the second piece of point data is stored in the first storage space as data A₂; and A₂ is output to the second storage space through the multiplier accumulator to obtain B₂=B₁+A₂*(1/N).

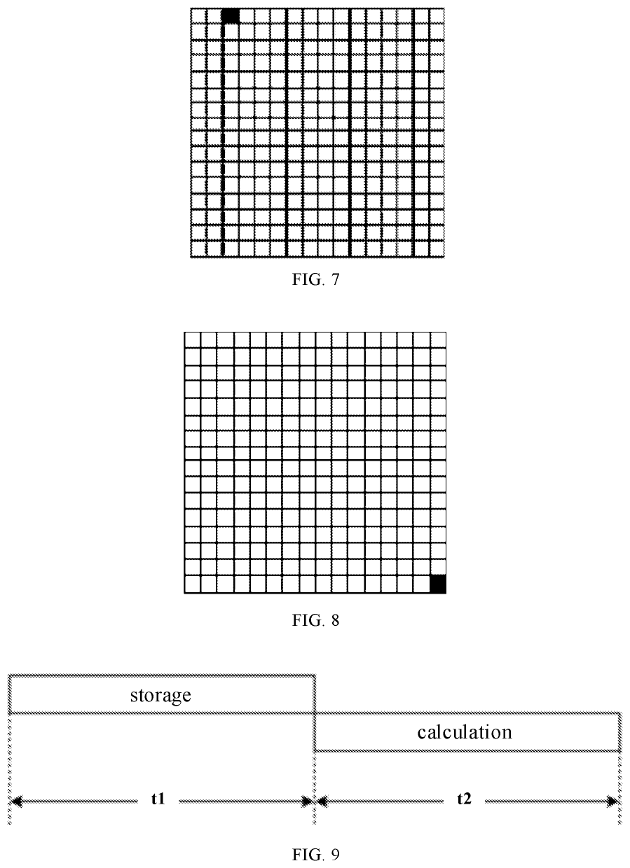

As shown in FIG. 7, when the n^{th} (n>2) piece of point data is received, the n^{th} piece of point data is stored in the first storage space as data Aₙ; and Aₙ is output to the second storage space through the multiplier accumulator to obtain Bₙ=Bₙ₋₁+Aₙ*(1/N).

At the operation S1-3, as shown in FIG. 8, an N^{th} piece of point data is received and stored in the first storage space as data A_{N}; and A_{N} is output to the second storage space through the multiplier accumulator to obtain B_{N}=B_{N-1}+A_{N}*(1/N), and finally the data B is equal to B_{N} and is taken as the final pooling result of the whole image.

According to the solution provided by the present disclosure, the storage space of the many-core system can be effectively utilized and the memory can be saved; meanwhile, by calculating the point data of the whole image piece by piece, the image processing efficiency can be improved and the calculation delay can be reduced. In a case where the to-be-processed data contain a large amount of point data, utilization of a chip per unit time can be greatly improved.

In another optional embodiment of the present disclosure, the preset pooling operation is the maximum pooling operation, and the process of acquiring the final pooling result of the to-be-processed data may include the following operations S2-1 to S2-3.

At the operation S2-1, a first piece of point data is received and stored in the first storage space as data A₁; and data B₀ in the second storage space is initialized to be negative infinity, and a maximum value B₁=Max(A₁,Bₙ₋₁) is stored in the second storage space, as shown in FIG. 5.

At the operation S2-2, an n^{th} piece of point data is received and stored in the first storage space as data Aₙ; and a maximum value Bₙ=Max(A₀,Bₙ₋₁) is stored in the second storage space.

As shown in FIG. 6, when a second piece of point data is received, the second piece of point data is stored in the first storage space as data A₂; and a maximum value B₂=Max(A₂,B₁) is stored in the second storage space.

As shown in FIG. 7, when the n^{th} (n>2) piece of point data is received, the n^{th} piece of point data is stored in the first storage space as data Aₙ; and the maximum value Bₙ=Max(A₂,Bₙ₋₁) is stored in the second storage space.

At the operation S2-3, as shown in FIG. 8, an N^{th} piece of point data is received and stored in the first storage space as data A_{N}; and a maximum value B_{N}=Max(A_{N},B_{N-1}) is stored in the second storage space, and finally the data B is equal to B_{N} and is taken as the final pooling result of the whole image.

N represents the number of the pieces of point data of the to-be-processed data, and 1<n<N. As can be seen, according to the solution provided by the present disclosure, the storage space of the many-core system can be effectively utilized and the memory can be saved; meanwhile, by calculating the point data of the whole image piece by piece, the image processing efficiency can be improved and the calculation delay can be reduced. In a case where the to-be-processed data contain a large amount of point data, the utilization of the chip per unit time can be greatly improved.

FIG. 9 is a schematic diagram of data processing time taken by a conventional solution, and FIG. 10 is a schematic diagram of data processing time according to the present disclosure. As shown in FIG. 9, it takes time t1+t2 to complete a pooling operation of an image in the related art. As shown in FIG. 10, storage and calculation may be performed in parallel by adopting the solution provided by the present disclosure, for example, the time taken for the storage is t1, the time taken for the calculation is t2, and the time taken for the parallel storage and calculation is T, then the total time for processing a whole image is t1+t2−T, which is less than the processing time shown in FIG. 9. The larger the image is, the more obvious the effect is. That is, the solution provided by the present disclosure may greatly reduce the storage size and the calculation delay.

For the storage, for example, for an image of 224*224, in the related art, global pooling needs to be performed after the whole image is stored, that is, the storage size of 224*224 needs to be occupied. However, according to the solution provided by the present disclosure, merely one piece of point data may be stored in each of the first storage space and the second storage space, respectively, that is, merely a storage size of 2 is occupied. As can be seen, with the solution provided by the present disclosure, the calculation may be performed with the storage size reduced to 2/(224*224) of the original storage, thereby greatly reducing the storage size.

For the calculation delay, for example, for the same image of 224*224, assuming that 1 clk is taken for receiving one piece of point data, and 1 clk is taken for one multiply-add-type operation.

In a case where the conventional solution is adopted, as shown in FIG. 9, the time taken for data reception is t1=(224*224) clks; the time taken for calculation is t2=(224*224) clks; and the time required for calculation of the image is t1+t2=(224*224+224*224) clks.

The solution provided by the present disclosure allows for parallel storage and calculation, so that the time required for calculation of the image is t1+1=(224*224+1) clks.

As can be seen, according to the present disclosure, a storage space of a chip can be saved, and the calculation delay can be reduced; furthermore, the utilization of the chip per unit time can be improved.

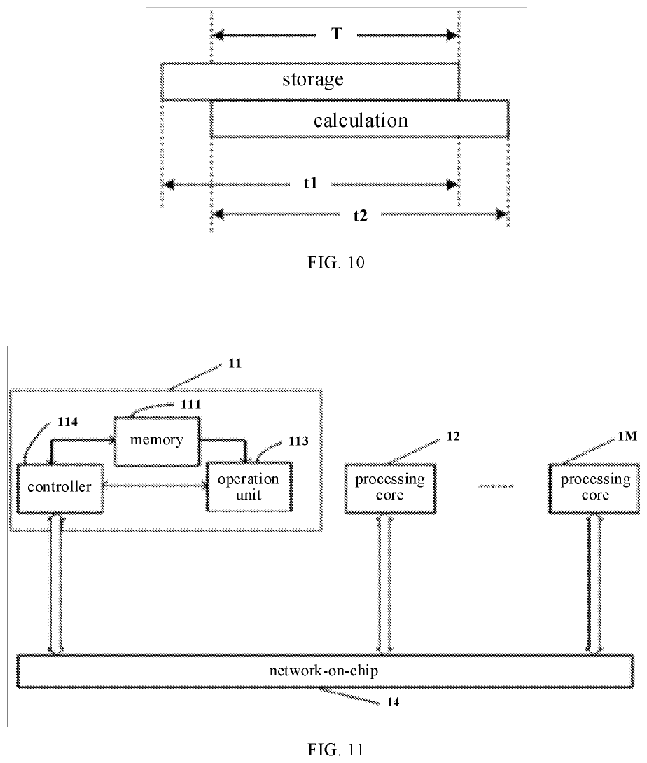

FIG. 11 is a schematic structural diagram of a many-core system according to the present disclosure. As shown in FIG. 11, in the present disclosure, the many-core system includes processing cores 11 to 1M and a network-on-chip 14. All of the processing cores 11 to 1M are connected to the network-on-chip 14. The network-on-chip 14 is configured for data interaction among the M processing cores and between the cores and outside. At least one of the M processing cores performs the following operations: receiving point data of to-be-processed data sequentially input by a previous network layer; and performing a preset pooling operation on the currently received point data after each piece of point data is received until the pooling operations of all the point data of the to-be-processed data are completed. A plurality of processing cores among the M processing cores may be mapped and perform global pooling operations at the same time, so as to improve data processing efficiency.

As shown in FIG. 11, a processing core 11 may include a memory 111, an operation unit 113 and a controller 114. The memory 111 is configured to store a processing instruction corresponding to the processing core 11, the to-be-processed data in a pooling layer among neural network layers and processed data. In another optional implementation, the memory 111 may include a first memory configured to store point data input by a previous network layer of the pooling layer among the neural network layers, and a second memory configured to store a pooling result after the point data is subjected to the preset pooling operation. The operation unit 113 is configured to perform the preset pooling operation on the point data. The controller 114 is configured to control the operation unit 113 to perform the preset pooling operation. The memory 111 is divided to separately store the point data and the pooling result, which may not only save the storage space of the chip, but also improve the utilization of the chip per unit time.

In an optional embodiment of the present disclosure, the operation unit 113 is configured to receive an n^{th} piece of point data of the to-be-processed data and perform the preset pooling operation on the n^{th} piece of point data based on a pooling result of an (n−1)^{th} piece of point data to obtain an n^{th} pooling result, and to receive an N^{th} piece of point data of the to-be-processed data and perform the preset pooling operation on the N^{th} piece of point data based on a pooling result of an (N−1)^{th} piece of point data to obtain an N^{th} pooling result. The N^{th} pooling result is a final pooling result of the to-be-processed data; and N represents the number of the pieces of point data of the to-be-processed data, and 1<n<N.

In an optional embodiment of the present disclosure, the operation unit 113 is configured to perform an average pooling operation on the point data in the memory 111, and the average pooling operation includes: receiving a first piece of point data and storing the first piece of point data in the first storage space as data A₁; initializing data in the second storage space to be 0, and storing data B₁=A₁*(1/N) in the second storage space; receiving an n^{th} piece of point data and storing in the first storage space as data Aₙ; outputting Aₙ to the second storage space through a multiplier accumulator to obtain Bₙ=Bₙ₋₁+Aₙ*(1/N); receiving an N^{th} piece of point data and storing in the first storage space as data A_{N}; and outputting A_{N} to the second storage space through the multiplier accumulator to obtain B_{N}=B_{N-1}+A_{N}*(1/N). N represents the number of the pieces of point data of the to-be-processed data, and 1<n<N.

In an optional embodiment of the present disclosure, the operation unit 113 is configured to perform a maximum pooling operation on the point data in the memory 111, and the maximum pooling operation includes: receiving a first piece of point data and storing in the first storage space as data A₁; initializing data B₀ in the second storage space to be negative infinity, and storing a maximum value B₁=Max(A₁,B₀) in the second storage space; receiving an n^{th} piece of point data and storing in the first storage space as data Aₙ; storing a maximum value Bₙ=Max(Aₙ,Bₙ₋₁) in the second storage space; receiving an N^{th} piece of point data and storing in the first storage space as data A_{N}; and storing a maximum value B_{N}=Max(A_{N},B_{N-1}) in the second storage space. N represents the number of the pieces of point data of the to-be-processed data, and 1<n<N.

The present disclosure further provides a computing device, including a many-core processor configured to run a computer program. When the many-core processor performs data processing, the global pooling method for a neural network provided by any one of the above embodiments is adopted.

In an optional embodiment of the present disclosure, the computing device further includes a storage device configured to store the computer program. The computer program is loaded and executed by the processor when the computer program is run in the computing device.

The global pooling method for a neural network and the many-core system provided by the present disclosure are more efficient, and can obtain the final pooling result of the to-be-processed data by performing the pooling operation on each piece of data point input by the previous network layer. With the solution provided by the present disclosure, the image operation can be replaced with the point operation in the row pipeline operation of the many-core system, so that the storage size and the calculation delay can be reduced.

In order to simplify the present disclosure and help understand one or more aspects of the present disclosure, a plurality of features of the present disclosure are sometimes grouped together in a single embodiment, drawing, or description thereof in the above description of the exemplary embodiments of the present disclosure.

The modules in the devices in the embodiments may be adaptively changed and arranged in one or more devices different from those disclosed in the embodiments. The modules or units or components in the embodiments may be combined into one module or unit or component, and may also be divided into a plurality of sub-modules or sub-units or sub-components. Except that at least some of the features and/or processes or units are mutually exclusive, all the features disclosed herein and all the processes or units of any method or device such disclosed may be combined in any way. Unless expressly stated otherwise, each feature disclosed herein may be replaced with an alternative feature capable of achieving the same, equivalent or similar objective.

Although some embodiments described herein include some features, but not other features, included in other embodiments, the combinations of the features of different embodiments are intended to fall within the scope of the present disclosure and form different embodiments.

The above embodiments are intended to illustrate but not limit the present disclosure. In the present disclosure, none of the reference numerals placed between parentheses shall be considered as limitations on the technical solutions. The term “comprising” does not exclude the existence of elements or operations which are not listed herein. The term “a” or “one” before an element does not exclude the existence of a plurality of such elements. The present disclosure can be implemented by means of hardware including different elements and by means of a properly programmed computer. In a plurality of devices listed, several of those devices can be implemented by one same hardware item. The terms “first”, “second” and “third” used herein do not indicate any sequence, and may be interpreted as names.

1. A global pooling method for a neural network applied to a many-core system, comprising:
receiving point data of to-be-processed data sequentially input by a previous network layer; and
performing a preset pooling operation on the received point data after each piece of point data is received until the pooling operations of all the point data of the to-be-processed data are completed.

2. The method of claim 1, wherein performing the preset pooling operation on the received point data after each piece of point data is received until the pooling operations of all the point data of the to-be-processed data are completed comprises:
receiving a first piece of point data input by the previous network layer, and performing the preset pooling operation on the first piece of point data to obtain a first pooling result; and
sequentially receiving the other pieces of point data of the to-be-processed data except the first piece of point data, and performing the preset pooling operation after each of the other pieces of point data is received until the pooling operations of all the point data of the to-be-processed data are completed to obtain a final pooling result.

3. The method of claim 2, wherein sequentially receiving the other pieces of point data of the to-be-processed data except the first piece of point data, and performing the preset pooling operation after each of the other pieces of point data is received until the pooling operations of all the point data of the to-be-processed data are completed to obtain the final pooling result comprises:
receiving an n^{th} piece of point data of the to-be-processed data, and performing the preset pooling operation on the n^{th} piece of point data based on a pooling result of an (n−1)^{th} piece of point data to obtain an n^{th} pooling result; and
receiving an N^{th} piece of point data of the to-be-processed data, and performing the preset pooling operation on the N^{th} piece of point data based on a pooling result of an (N−1)^{th} piece of point data to obtain an N^{th} pooling result;
wherein the N^{th} pooling result is the final pooling result of the to-be-processed data; and N represents the number of the pieces of point data of the to-be-processed data, and 1<n<N.

4. The method of claim 1, wherein the preset pooling operation comprises average pooling or maximum pooling.

5. The method of claim 4, wherein a storage space of the many-core system comprises a first storage space and a second storage space;
in a case where the preset pooling operation is an average pooling operation, performing the preset pooling operation on the received point data after each piece of point data is received until the pooling operations of all the point data of the to-be-processed data are completed comprises:
receiving a first piece of point data and storing the first piece of point data in the first storage space as data A₁; initializing data in the second storage space to be 0, and storing data B₁=A₁*(1/N) in the second storage space;
receiving an n^{th} piece of point data and storing in the first storage space as data Aₙ; outputting Aₙ to the second storage space through a multiplier accumulator to obtain Bₙ=Bₙ₋₁+Aₙ*(1/N);
receiving an N^{th} piece of point data and storing in the first storage space as data A_{N}; and outputting A_{N} to the second storage space through the multiplier accumulator to obtain B_{N}=B_{N-1}+A_{N}*(1/N);
wherein N represents the number of the pieces of point data of the to-be-processed data, and 1<n<N.

6. The method of claim 4, wherein a storage space of the many-core system comprises a first storage space and a second storage space;
in a case where the preset pooling operation is a maximum pooling operation, performing the preset pooling operation on the received point data after each piece of point data is received until the pooling operations of all the point data of the to-be-processed data are completed comprises:
receiving a first piece of point data and storing in the first storage space as data A₁; initializing data B₀ in the second storage space to be negative infinity, and storing a maximum value B₁=Max(A₁,B₀) in the second storage space;
receiving an n^{th} piece of point data and storing in the first storage space as data Aₙ; storing a maximum value Bₙ=Max(Aₙ,Bₙ₋₁) in the second storage space; and
receiving an N^{th} piece of point data and storing in the first storage space as data A_{N}; and storing a maximum value B_{N}=Max(A_{N},B_{N-1}) in the second storage space;
wherein N represents the number of the pieces of point data of the to-be-processed data, and 1<n<N.

7. A many-core system, comprising:
a plurality of processing cores, at least one of the plurality of processing cores performs the following operations:
receiving point data of to-be-processed data sequentially input by a previous network layer; and
performing a preset pooling operation on the received point data after each piece of point data is received until the pooling operations of all the point data of the to-be-processed data are completed.

8. The many-core system of claim 7, wherein each processing core comprises:
a controller configured to control reception and storage of the point data input by the previous network layer;
a memory configured to store the point data; and
an operation unit configured to perform the preset pooling operation on the point data under the control of the controller.

9. A non-transient computer-readable storage medium having a computer program stored therein, wherein the program is executed by a processor to implement the global pooling method for a neural network of claim 1.

10. (canceled)
